(19) United States
(12) Patent Application Publication
(10) Pub. No.: US 2026/0168613 A1
(43) Pub. Date: Jun. 18, 2026

(54) BRACKET ASSEMBLY AND DISPLAY DEVICE INCLUDING THE SAME

(71) Applicant: LG ELECTRONICS INC., Seoul (KR)

(72) Inventors: Wuram CHOI, Seoul (KR); Jingyu KIM, Seoul (KR); Seayoung CHO, Seoul (KR); Sunghun LEE, Seoul (KR)

(73) Assignee: LG ELECTRONICS INC., Seoul (KR)

(21) Appl. No.: 19/420,009

(22) Filed: Dec. 15, 2025

(30) Foreign Application Priority Data
Dec. 16, 2024 (KR) 10-2024-0187498
Feb. 13, 2025 (KR) 10-2025-0018933

(51) Int. Cl. F16M 11/10

(52) U.S. Cl. CPC F16M 11/10

(57) ABSTRACT

A display device including a display; a frame to which the display is coupled; a back cover which is coupled to the frame, and positioned opposite to the display with respect to the frame; and a bracket assembly which is coupled to the back cover, and is detachable, wherein the bracket assembly includes: a body frame coupled to the back cover; and a folio bracket which is hinge-connected to the body frame, and is able to tilt.

### CROSS-REFERENCE TO RELATED APPLICATION

Pursuant to 35 U.S.C. § 119(a), this application claims the benefit of earlier filing date and right of priority to Korean Patent Application Nos. 10-2024-0187498, filed on Dec. 16, 2024, and 10-2025-0018933, filed on Feb. 13, 2025, the contents of which are all hereby incorporated by reference herein in their entireties.

### TECHNICAL FIELD

This disclosure relates to a bracket assembly and a display device including the same.

### BACKGROUND

As the information society develops, the demand for display devices is also increasing in various forms, and in response to this, various display devices such as Liquid Crystal Display Device (LCD), Plasma Display Panel (PDP), Electro luminescent Display (ELD), Vacuum Fluorescent Display (VFD), and Organic Light Emitting Diode (OLED) have been studied and used recently.

Among these, the LCD panel has a TFT substrate and a color substrate that are opposite to each other with a liquid crystal layer interposed therebetween, and may display images by using light provided from a backlight unit. In addition, an OLED panel may display images by depositing an organic layer that can emit light naturally on a substrate on which a transparent electrode is formed.

Recently, much research has been conducted on a structure that can freely adjust the angle or position of a display.

### SUMMARY

The disclosure has been made in view of the above problems, and may provide a display device having a stand for supporting a display.

The disclosure may further provide a display device capable of freely adjusting the angle or height of a display.

The disclosure may further provide a display device capable of improving durability for repeated operations of freely adjusting the angle or height of a display.

The disclosure may further provide a display device capable of attaching a display to a stand or detaching the display from the stand.

The disclosure may further provide a display device having a folio bracket assembly for mounting a display.

The disclosure may further provide a display device capable of being mounted by a folio cover.

In accordance with an aspect of the present disclosure, a display device includes: a display panel; a frame to which the display panel is coupled; a back cover which is coupled to the frame, and positioned opposite to the display panel with respect to the frame; and a bracket assembly which is coupled to the back cover, and is detachable, in which the bracket assembly includes: a body frame coupled to the back cover; and a folio bracket which is hinge-connected to the body frame, and is able to tilt.

In accordance with another aspect of the present disclosure, a bracket assembly includes: a body frame; a body cover which faces the body frame, and is coupled to the body frame; a bracket hinge slider which reciprocates between the body frame and the body cover; and a folio bracket which is positioned opposite to the body cover with respect to the body frame, and is hinge-connected to the body frame and able to tilt, in which the bracket hinge slider reciprocates in conjunction with tilting of the folio bracket.

### BRIEF DESCRIPTION OF THE DRAWINGS

The above and other objects, features and advantages of the present disclosure will be more apparent from the following detailed description in conjunction with the accompanying drawings, in which:

FIGS. 1 to 39 are drawings illustrating examples of a bracket assembly and a display device including the same according to embodiments of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

When an element is referred to as being “coupled,” “fixed,” “mounted,” “connected,” “linked,” etc. to another element, there may be intervening elements present. When an element is referred to as being “directly coupled,” “directly fixed,” “directly mounted,” “directly connected,” “directly linked” etc. to another element, there are no intervening elements present.

A singular representation may include a plural representation unless context clearly indicates otherwise.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

The direction indications of up U, down D, left Le, right Ri, front F, and rear R shown in the drawings are only for the convenience of explanation, and the technical concepts disclosed in this specification are not limited thereby.

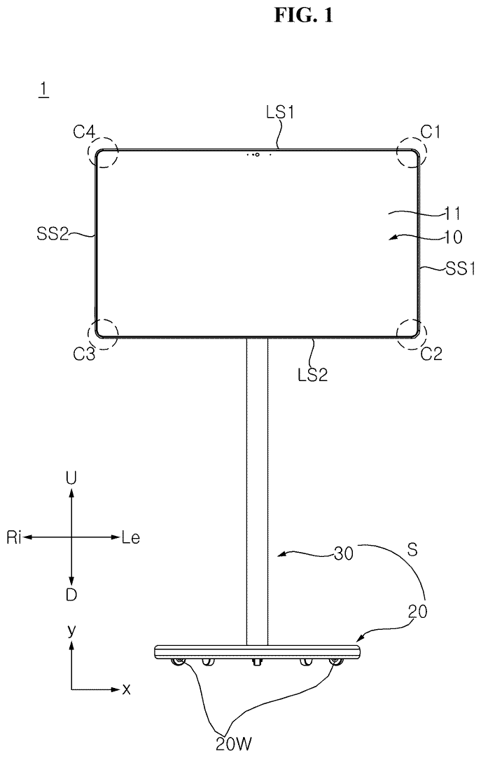

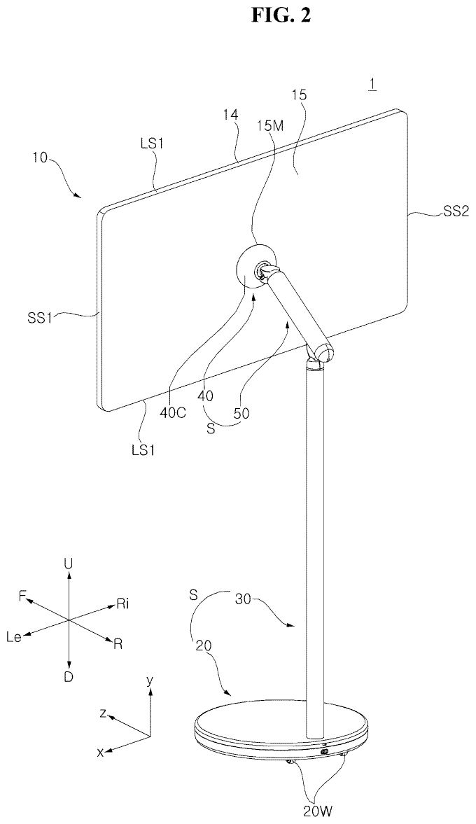

Referring to FIGS. 1 and 2, a display device 1 may include a display 10. The display 10 may include a display panel 11 that displays an image. The front surface of the display panel 11 may display an image. The display 10 may be referred to as a display unit 10 or a display head 10.

The display 10 may include a first long side LS1, a second long side LS2 opposite to the first long side LS1, a first short side SS1 adjacent to the first long side LS1 and the second long side LS2, and a second short side SS2 opposite to the first short side SS1. Meanwhile, for convenience of explanation, it is illustrated that the lengths of the first and second long sides LS1 and LS2 are longer than the lengths of the first and second short sides SS1 and SS2, but it may be possible that the lengths of the first and second long sides LS1 and LS2 are approximately the same as the lengths of the first and second short sides SS1 and SS2.

The direction parallel to the short sides SS1, SS2 of the display 10 may be referred to as an up-down direction. The direction parallel to the long sides LS1, LS2 of the display 10 may be referred to as a left-right direction. The direction perpendicular to the short sides SS1, SS2 and long sides LS1, LS2 of the display 10 may be referred to as a front-rear direction.

The direction in which the display 10 displays an image may be referred to as a front (F, z), and the opposite direction may be referred to as a rear R. The first short side SS1 side may be referred to as a left (Le, x). The second short side SS2 side may be referred to as a right Ri. The first long side LS1 side may be referred to as an upper side (U, y). The second long side LS2 side may be referred to as a lower side D.

The first long side LS1, the second long side LS2, the first short side SS1, and the second short side SS2 may be referred to as an edge of the display 10. The point where the first long side LS1, the second long side LS2, the first short side SS1, and the second short side SS2 meet each other may be referred to as a corner. The point where the first long side LS1 and the first short side SS1 meet may be referred to as a first corner C1. The point where the first short side SS1 and the second long side LS2 meet may be referred to as a second corner C2. The point where the second long side LS2 and the second short side SS2 meet may be referred to as a third corner C3. The point where the second short side SS2 and the first long side LS1 meet may be referred to as a fourth corner C4.

A stand S may support the display 10. The stand S of the display device 1 may be placed on the ground, and the display 10 of the display device 1 may be separated from the ground by the stand S. The stand S may include a base 20, a pole 30, pole, a connector 40, and a support arm 50.

The base 20 may be placed on the ground. The base 20 may be round or angular. A plurality of wheels 20W may be mounted on the base 20. The base 20 may be referred to as a moving base 20.

The pole 30 may extend from the base 20. The length direction of the pole 30 may be parallel to a vertical direction. The lower end of the pole 30 may be adjacent to the perimeter of the base 20 to be coupled to the base 20.

The support arm 50 may extend in a direction intersecting with the pole 30. The support arm 50 may be adjacent to the upper end of the pole 30 to be coupled to the pole 30. The connector 40 may be positioned between the display 10 and the support arm 50, and may be coupled to the display 10 and the support arm 50.

Accordingly, the display 10 may be supported by the stand S, and may be positioned away from the ground on which the base 20 is placed.

Meanwhile, a battery (not shown) may be embedded in at least one of the base 20, the pole 30, the support arm 50, and the display 10. The display device 1 may be driven by receiving power from the battery.

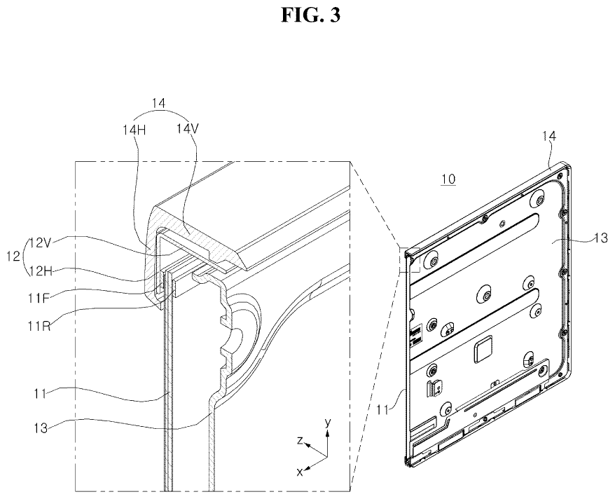

Referring to FIG. 3, the display 10 may include a display panel 11, a middle cabinet 12, a frame 13, a side frame 14, and a back cover 15 (see FIG. 2).

The display panel 11 may form the front surface of the display 10. For example, the display panel 11 may be a Liquid Crystal Display (LCD) panel, an Organic Light Emitting Diode (OLED) panel, or a Light Emitting Diode (LED) panel. The display panel 11 may output an image by dividing an image into a plurality of pixels and adjusting the color, brightness, and saturation for each pixel. The display panel 11 may be divided into an active area where an image is displayed and a de-active area where an image is not displayed. The display panel 11 may generate light corresponding to the color of red, green, or blue according to a control signal.

The middle cabinet 12 may extend along the edge of the display panel 11. The horizontal portion 12H may be positioned in front of the display panel 11. The vertical portion 12V may intersect with the horizontal portion 12H, and cover the side surface of the display panel 11. The middle cabinet 12 may be omitted. A front pad 11F may be positioned between the horizontal portion 12H and the display panel 11, and may be coupled to the horizontal portion 12H. A rear pad 11R may be opposite to the front pad 11F with respect to the display panel 11.

The frame 13 may be positioned at the rear of the display panel 11. Electronic components such as a Printed Circuit Board (PCB) may be mounted on the frame 13. For example, a power supply board, a timing controller board, and a main board may be coupled to the rear of the frame 13.

The side frame 14 may extend along the edge of the frame 13. The side frame 14 may form the edge of the display 10. The horizontal portion 14H may be positioned at the front of the horizontal portion 12H of the middle cabinet 12. The vertical portion 14V may cover the vertical portion 12V of the middle cabinet 12.

The back cover 15 may form the rear surface of the display 10. The back cover 15 may cover the rear of the frame 13, and may be coupled to the frame 13.

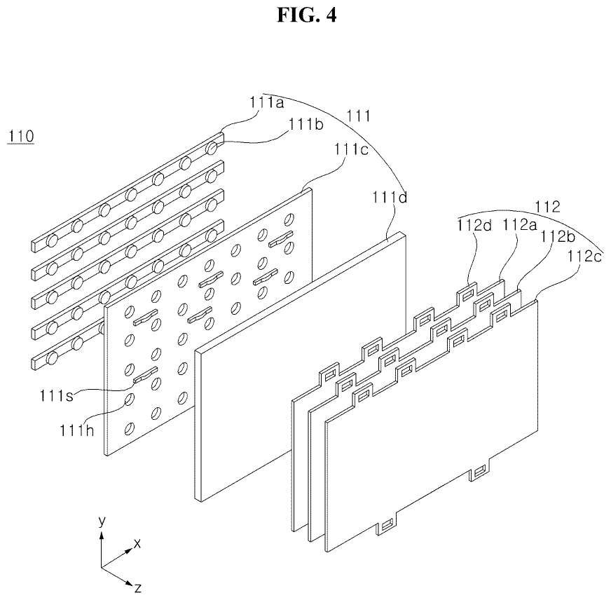

Referring to FIGS. 3 and 4, a backlight unit 110 may be positioned between the display panel 11 and the frame 13, and may be coupled to the frame 13. The display panel 11 may be referred to as an LCD panel 11. The backlight unit 110 may include an optical layer 111 and an optical sheet 112.

The optical layer 111 may include a substrate 111a, at least one light source 111b such as an Light Emitting Diode (LED), a reflective sheet 111c, and a diffusion plate 111d. The reflective sheet 111c may have a hole 111h in which a light source 111b is positioned. The diffusion plate 111d may be positioned in front of the reflective sheet 111c. A spacer 111s may support the rear surface of the diffusion plate 111d at between the reflective sheet 111c and the diffusion plate 111d.

The optical sheet 112 may be positioned in front of the diffusion plate 111d. The optical sheet 112 may include at least one of a diffusion sheet or a prism sheet. For example, the optical sheet 112 may be composed of a plurality of layers 112a, 112b, 112c. A coupling portion 112d of the optical sheet 112 may be coupled to the frame 13.

Accordingly, the light of the light source 111b may be provided to the display panel 11 through the diffusion plate 111d and the optical sheet 112. Meanwhile, the display panel 11 of the present disclosure may be an OLED panel that does not require the aforementioned backlight unit 110 or may be another type of panel.

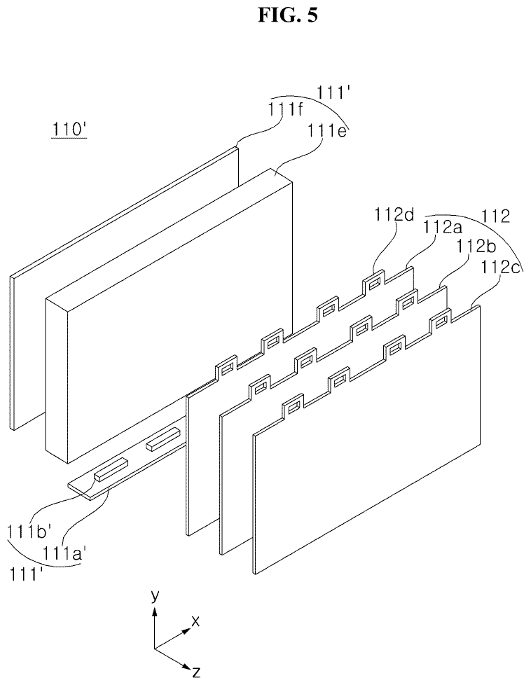

Referring to FIGS. 3 and 5, a backlight unit 110′may be positioned between the display panel 11 and the frame 13, and may be coupled to the frame 13. The display panel 11 may be referred to as an LCD panel 11. The backlight unit 110′may include an optical layer 111′and the optical sheet 112.

The optical layer 111′may include a substrate 111a', at least one light source 111b′ such as an Light Emitting Diode (LED), a reflective sheet 111f, and a light guide plate 111e. The light guide plate 111e may be positioned between the frame 13 and the optical sheet 112, and may be supported by the frame 13. The reflective sheet 111f may be positioned between the frame 13 and the light guide plate 111e, and may be supported by the frame 13.

Accordingly, light from the light source 111b′ may be provided to the display panel 11 through the light guide plate 111e and the optical sheet 112. Meanwhile, the display panel 11 of the present disclosure may be an OLED panel that does not require the aforementioned backlight unit 110′ or may be another type of panel.

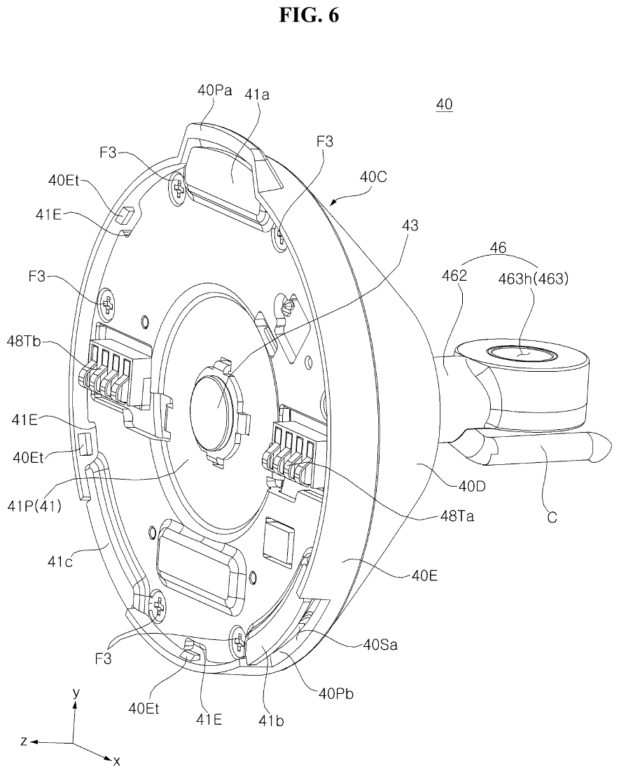

Referring to FIG. 6, a cover 40C may have a bowl shape that is open in a forward direction. A middle part 462 of a holder 46 and a rear part 463 having a hole 463h formed by vertically penetrating the center may be positioned at the rear of the cover 40C. The cover 40C may include a dome 40D and a side wall 40E. The cover 40C may be referred to as a rear cover 40C. A cable C may be routed to the lower portion of the holder 46.

A dome 40D may be convex in a rearward direction. A fastening member F3 may penetrate a front bracket 41. For example, the fastening member F3 may be a screw. The fastening members F3 may be arranged along the edge of the front bracket 41. The front bracket 41 may be referred to as a pressed portion 41P.

A side wall 40E may extend in a forward direction from the edge of the dome 40D. The side wall 40E may be formed along the edge of the dome 40D. The side wall 40E may cover the edge of the front bracket 41. A protrusion 40Et may be formed on the inner surface of the side wall 40E. A plurality of protrusions 40Et may be arranged along the side wall 40E. The protrusion 40Et may be referred to as a hook 40Et. A groove 41E may be formed on the edge of the front bracket 41 and may be positioned to correspond to the protrusion 40Et.

A protruding portion 40Pa may protrude from the outer surface of the side wall 40E. A first connecting portion 41a of the front bracket 41 may be positioned to correspond to the protruding portion 40Pa.

A first groove 40Pb may be formed from the front end of the side wall 40E to the rear side of the side wall 40E. A second connecting portion 41b of the front bracket 41 may be positioned to correspond to the first groove 40Pb. The second connecting portion 41b may be positioned in front of the first groove 40Pb. A slot 40Sa may be formed between the second connecting portion 41b and the first groove 40Pb.

A third connecting portion 41c of the front bracket 41 may be positioned between the second connecting portion 41b and the first connecting portion 41a in the circumferential direction of the front bracket 41. The front bracket 41 may rotate around a pivot shaft 43.

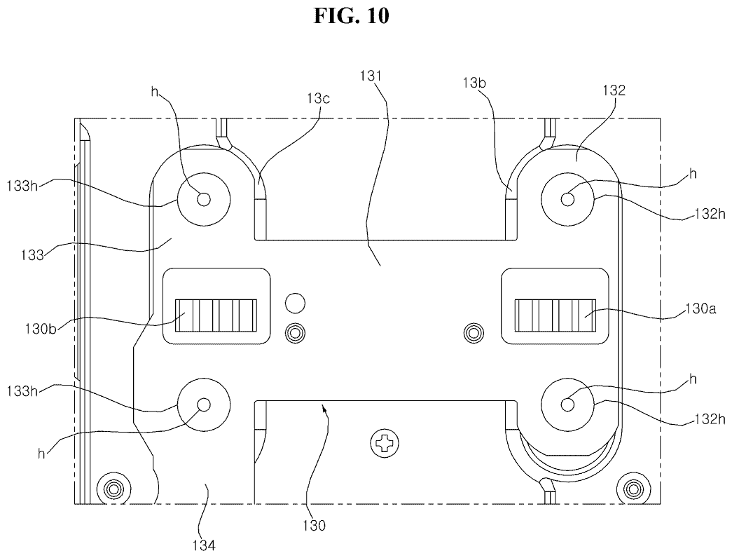

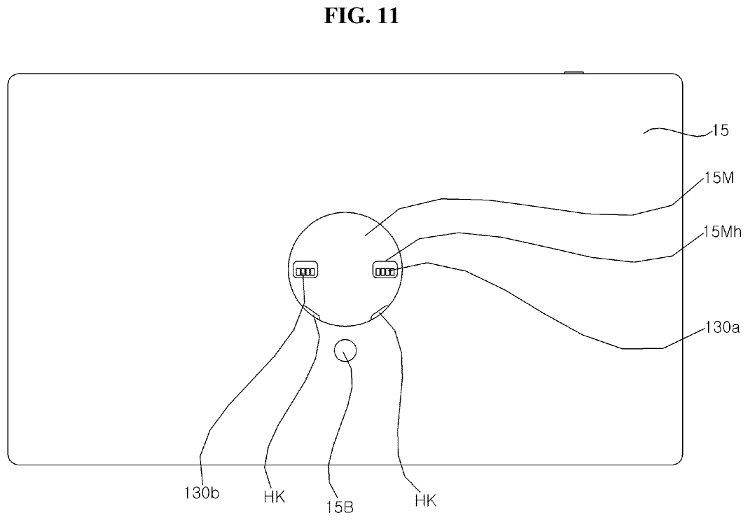

Terminals 48Ta, 48Tb of the connector 40 may be electrically connected to terminals 130a, 130b (see FIG. 10 and FIG. 11) of the display 10.

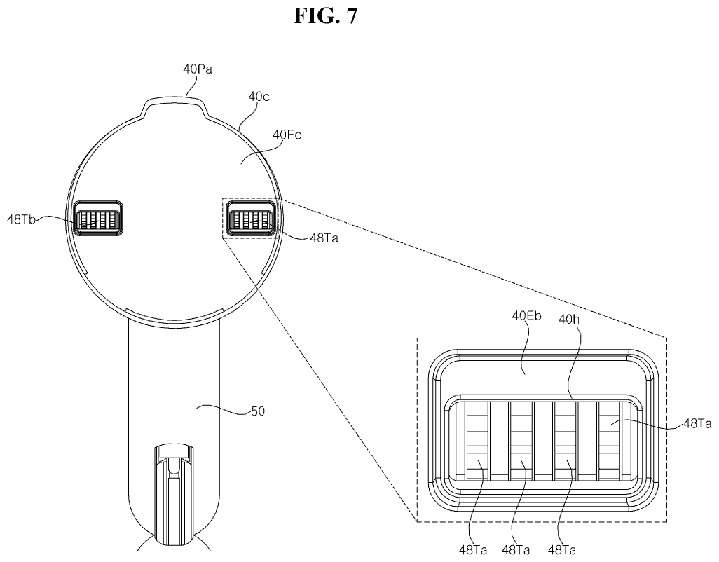

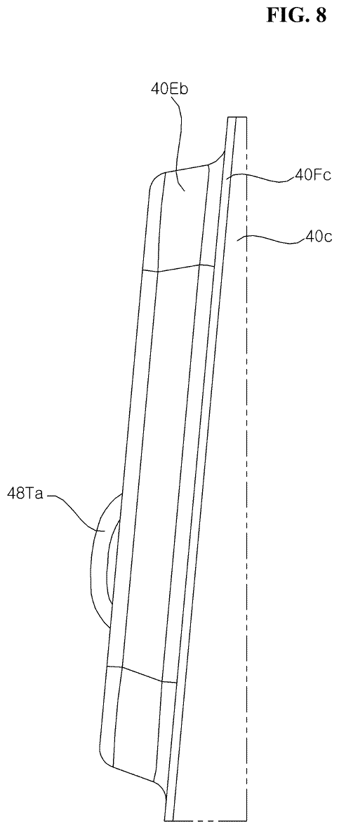

Referring to FIG. 7 and FIG. 8, a front cover 40Fc may cover the front bracket 41 (see FIG. 6). The front cover 40Fc may be coupled to the rear cover 40C. The front cover 40Fc may include a terminal barrier 40Eb. The terminal barrier 40Eb may form a step raised from the outer surface of the front cover 40Fc, and protrude. For example, the terminal barrier 40Eb may be rectangular overall. There may be a plurality of terminal barriers 40Eb. Each of the plurality of terminal barriers 40Eb may correspond to each of the plurality of terminals 48Ta. The terminal 48Ta may be referred to as connection terminal 48Ta or a connection electrode 48Ta.

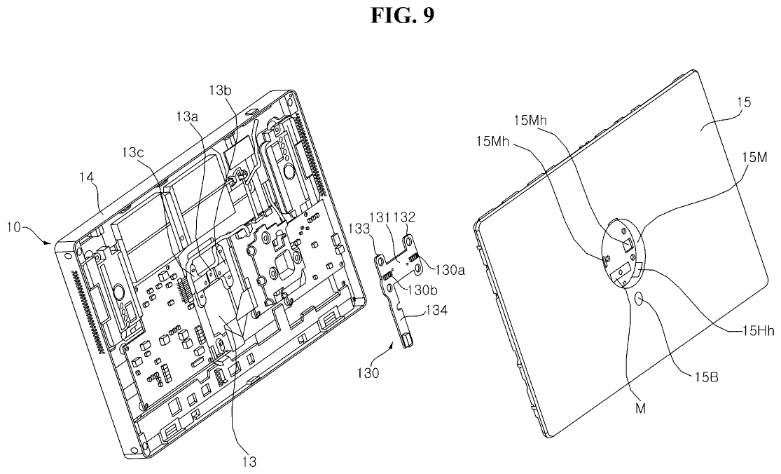

The front cover 40Fc may include a terminal hole 40h penetrating the terminal barrier 40Eb. The terminal hole 40h may be rectangular overall. The terminal hole 40h may expose the terminal 48Ta to the outside. The terminal 48Ta may protrude from the outer surface of the terminal barrier 40Eb through the terminal hole 40h. The size of the terminal barrier 40Eb may correspond to the size of the terminal hole 15Mh (see FIG. 9) of the back cover 15 (see FIG. 9). The terminal barrier 40Eb may be inserted into the terminal hole 15Mh (see FIG. 9) of the back cover 15 (see FIG. 9).

Accordingly, the terminal 48Ta, 48Tb exposed to the outside may be protected, and the alignment or docking property of the display 10 (see FIG. 2) and the connector 40 (see FIG. 2) may be improved. In addition, the inflow of foreign substances may be prevented, thereby suppressing noise.

Referring to FIGS. 9 and 10, the frame 13 may include a substrate mount 13a, 13b, 13c. The substrate mount 13a, 13b, 13c may form a high step from the rear surface of the frame 13 to the rear of the frame 13. The substrate mount 13a, 13b, 13c may include a first part 13a, a second part 13b, and a third part 13c. For example, the substrate mount 13a, 13b, 13c may have a H-shape as a whole.

The first part 13a of the substrate mount 13a, 13b, 13c may be extended long in the left-right direction of the frame 13. The second part 13b may be extended long in the up-down direction from one end of the first part 13a. The third part 13c may be extended long in the up-down direction from the other end of the first part 13a. The third part 13c may be positioned opposite to the second part 13b with respect to the first part 13a. A fastening hole h may be formed on the upper and lower sides of the second part 13b. The fastening hole h may be formed on the upper and lower sides of the third part 13c. The fastening hole h may be a groove or a through hole formed in the frame 13.

A head substrate 130 may correspond to the substrate mount 13a, 13b, 13c. The head substrate 130 may include a first substrate 131, a second substrate 132, and a third substrate 133. The first substrate 131 may extend long in a left-right direction. The first substrate 131 may be positioned on the first part 13a of the substrate mount 13a, 13b, 13c. The first part 13a of the substrate mount 13a, 13b, 13c may support the first substrate 131. The second substrate 132 may extend in the up-down direction from one side of the first substrate 131. The third substrate 133 may extend in the up-down direction from the other side of the first substrate 131. The third substrate 133 may be positioned opposite to the second substrate 132 with respect to the first substrate 131. The second substrate 132 may be positioned on the second part 13b of the substrate mount 13a, 13b, 13c, and the third substrate 133 may be positioned on the third part 13c of the substrate mount 13a, 13b, 13c. The second part 13b of the substrate mount 13a, 13b, 13c may support the second substrate 132, and the third part 13c may support the third substrate 133.

The second substrate 132 may include an upper hole 132h and a lower hole 132h that correspond to the fastening holes h formed in the second part 13b of the substrate mount 13a, 13b, 13c. The third substrate 133 may include an upper hole 133h and a lower hole 133h that correspond to the fastening holes h formed in the third part 13c of the substrate mount 13a, 13b, 13c. Each of the upper holes 132h, 133h and/or each of the lower holes 132h, 133h may be aligned with each of the fastening holes h of the substrate mount 13a, 13b, 13c. The upper hole 132h, 133h may be referred to as an upper substrate hole 132h, 133h or a first substrate hole 132h, 133h, and the lower hole 132h, 133h may be referred to as a lower substrate hole 132h, 133h or a second substrate hole 132h, 133h.

A first substrate terminal 130a may be mounted on the second substrate 132. The first substrate terminal 130a may be positioned between the upper hole 132h and the lower hole 132h. A second substrate terminal 130b may be mounted on the third substrate 133. The second substrate terminal 130b may be positioned between the upper hole 133h and the lower hole 133h. The substrate terminal 130a, 130b may be referred to as a head terminal 130a, 130b.

An extension substrate 134 may be connected to the third substrate 133. The extension substrate 134 may be extended downward from the third substrate 133. The extension substrate 134 may be replaced with a wire or a cable.

The back cover 15 may include a mount 15M. The mount 15M may be referred to as a connector mount 15M. The mount 15M may form a low step from the outer surface of the back cover 15. The mount 15M may include a terminal hole 15Mh. There may be a plurality of terminal holes 15Mh. The terminal hole 15Mh may be formed by penetrating the mount 15M. For example, a pair of terminal holes 15Mh may be aligned left and right. The pair of terminal holes 15Mh may be aligned to the first substrate terminal 130a and the second substrate terminal 130b.

The head magnet M may be fixed to the mount 15M. The head magnet M may be positioned below the terminal hole 15Mh. A hook hole 15Hh may be formed on the side wall of the mount 15M. For example, the mount 15M may be circular. For example, the hook hole 15Hh may be formed on the side wall surface of the mount 15M. A button 15B may be coupled to the back cover 15. The button 15B may be positioned between the hook holes 15Hh.

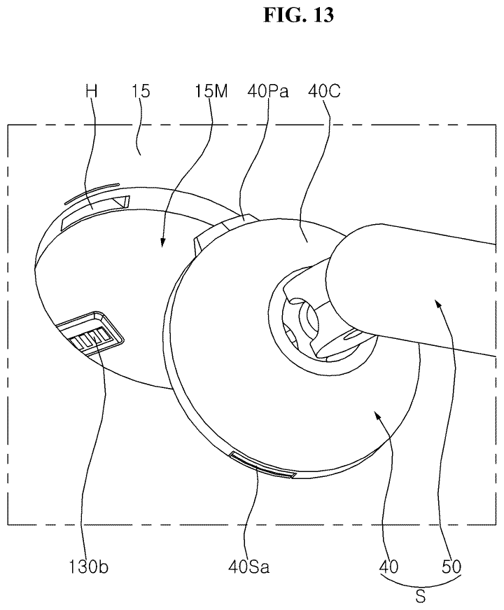

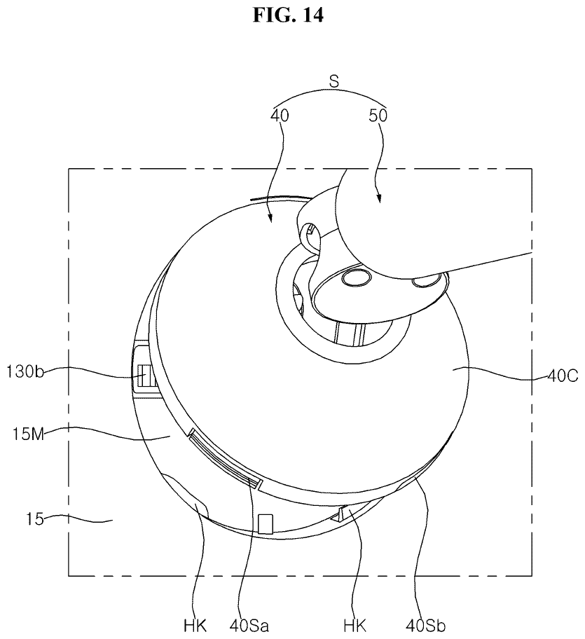

Referring to FIGS. 11 to 15, the first terminal 130a and/or the second terminal 130b may be exposed to the outside of the back cover 15 through the terminal holes 15Mh of the mount 15M of the back cover 15. The hooks HK may protrude or retract toward the hook holes 15Hh (see FIG. 9) of the mount 15M in conjunction with a button 15B provided on the back cover 15.

Terminals 48Ta, 48Tb exposed to the outside of the connector 40 through the terminal barrier 40Eb (see FIG. 7) and terminal holes 40h (see FIG. 7) of the front cover 40Fc of the connector 40 may be connected to substrate terminal 130a, 130b exposed to the outside of the back cover 15 through the terminal holes 15Mh of the back cover 15 when the connector 40 is coupled to the mount 15M of the back cover 15.

Accordingly, when the connector 40 (see FIG. 2) and the display 10 (see FIG. 2) are electrically connected, and even if the display 10 (see FIG. 2) repeatedly pivots and rotates, the electrical connection between the connector 40 (see FIG. 2) and the display 10 (see FIG. 2) may be stably maintained.

The connector 40 to which a support arm 50 is connected may be coupled to or separated from the display head 10. The connector 40 may be aligned with the mount 15M of the back cover 15 and coupled to or separated from the mount 15M. The button 15B may be a trigger of a mechanism by which the connector 40 is separated from the mount 15M of the back cover 15. For example, when the connector 40 is coupled to the mount 15M of the back cover 15, the button 15B may be operated manually. For another example, the connector 40 coupled to the mount 15M of the back cover 15 may be separated from the mount 15M of the back cover 15 by an operation of pressing the button 15B. The button 15B may be a mechanical button or an electronic button.

The mount 15M of the back cover 15 may form a low step from the rear surface of the back cover 15. The mount 15M may be formed as one body with the back cover 15, or may be formed separately. For example, the mount 15M may be a circular recessed portion, and the front cover 40Fc (see FIG. 7) and/or the rear cover 40C of the connector 40 may have an overall conical shape. The mount 15M of the back cover 15 may be coupled to or fixed to the frame 13 (see FIG. 9). For example, the mount 15M of the back cover 15 may be fixed to the rear surface of the frame 13 (see FIG. 9) by a fastening member.

The connector 40 may be coupled while being inserted into the mount 15M of the back cover 15. The protruding portion 40Pa of the rear cover 40C of the connector 40 and/or the coupling portion 41a of the front bracket 41 (see FIG. 6) may be inserted into a fixing hole H of the mount 15M of the back cover 15. Accordingly, the connector 40 may be temporarily fixed to the display head 10.

When the connector 40 is inserted into the mount 15M, a coupling hook HK embedded in the back cover 15 may be inserted into the slot 40Sa, 40Sb of the connector 40. The coupling hook HK may reciprocate from the inside to the outside of the back cover 15. There may be a plurality of coupling hooks HK. For example, the coupling hook HK may be configured to be a pair so as to achieve a stability of coupling. The protruding portion 40Pa and/or the coupling portion 41a (see FIG. 6) of the connector 40 may be inserted into the fixing hole H of the back cover mount 15M, and the connector 40 may be fixed to the display head 10 when the pair of coupling hooks HK are inserted into the slots 40Sa, 40Sb of the connector 40, respectively.

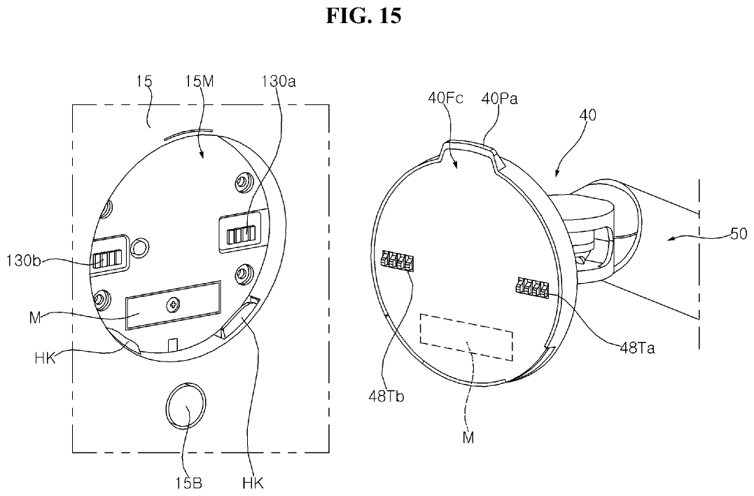

The head magnet M may be coupled to the mount 15M of the back cover 15. The connector magnet M may be coupled to the inside of the front cover 40Fc of the connector 40. The connector magnet M may be coupled to the front bracket 41 (see FIG. 15).

When the connector 40 is coupled to the mount 15M of the back cover 15, an attractive force may be applied to the head magnet M and the connector magnet M. Accordingly, the connector 40 may provide an auxiliary coupling force in the process of being coupled to the display head 10.

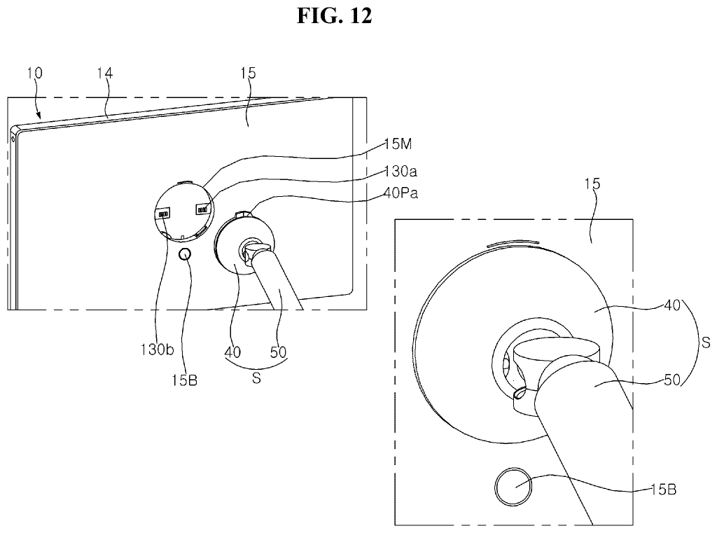

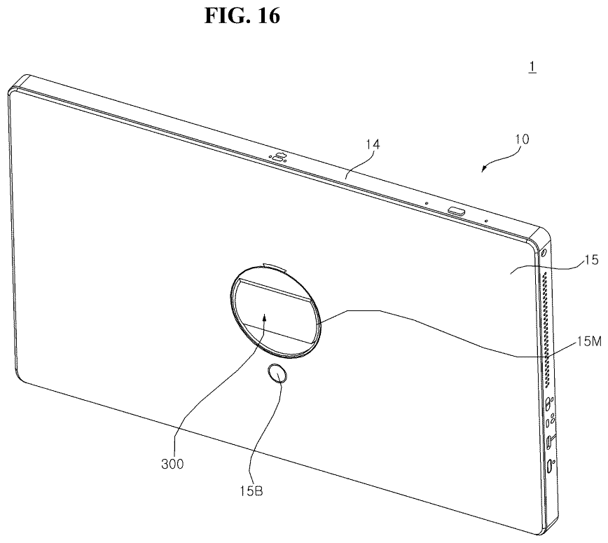

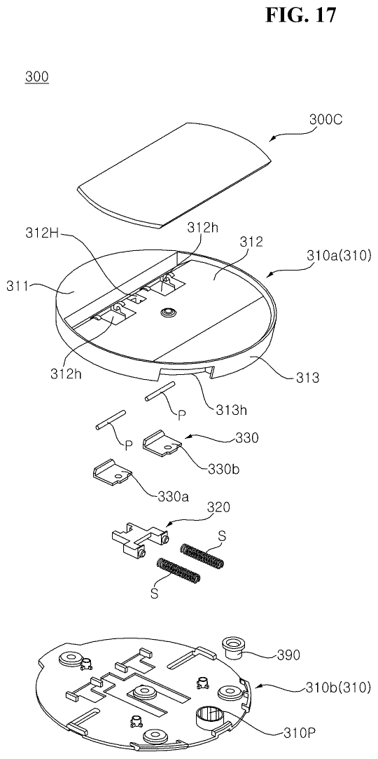

Referring to FIGS. 16 and 17, the bracket assembly 300 may be coupled to the mount 15M of the back cover 15 of the display head 10. The connector 40 (see FIG. 12) may be separated from the mount 15M of the display head 10, and the bracket assembly 300 may be coupled to the mount 15M of the back cover 15 of the display head 10. When the button 15B is pressed, the bracket assembly 300 may be separated from the display head 10.

The bracket assembly 300 may include at least one of a body frame 310a (310), a bracket hinge slider 320, a body cover 310b (310), and a folio bracket 300C. For example, the body frame 310a and/or the body cover 310b may have an overall disc shape.

The body frame 310a may include an outer plate 311 and a side plate 313. The side plate 313 may form a side surface of the body frame 310a. The outer plate 311 may be connected to the side plate 313 and form an outer surface. For example, the outer plate 311 may have a disc shape, and the side plate 313 may have a ring shape.

The body frame 310a may include a bracket mount 312. The bracket mount 312 may form a low step from the outer plate 311 of the body frame 310a. A coupling opening 312h may penetrate the bracket mount 312. There may be a plurality of coupling openings 312h. A cam hole 312H may be positioned between the plurality of coupling openings 312h. The cam hole 312H may penetrate the bracket mount 312. A hook coupling groove 313h may be formed in the side plate 313 of the body frame 310a.

The body cover 310b may be coupled to the body frame 310a. The body frame 310a may provide an accommodation space therein by the outer plate 311 and the side plate 313. The body cover 310b may cover the accommodation space of the body frame 310a. The body cover 310b may be positioned opposite to the outer plate 311 with respect to the side plate 313 of the body frame 310a.

The bracket hinge slider 320 may be positioned between the body frame 310a and the body cover 310b. The bracket hinge slider 320 may reciprocally move in the body frame 310a. An elastic member S may provide elasticity to the bracket hinge slider 320.

The folio bracket 300C may be positioned in the bracket mount 312. The folio bracket 300C may open and close the bracket mount 312. The folio bracket 300C may be hinge-connected to the body frame 310a by a pin coupler 330 (330a, 330b) and a pin P. The folio bracket 300C may pivot about the pin P.

An ejector 390 may be movably coupled to the body cover 310b. The body cover 310b may have an ejector housing 310P. For example, the ejector housing 310P may have a cylinder shape. The ejector 390 may reciprocate within the ejector housing 310P.

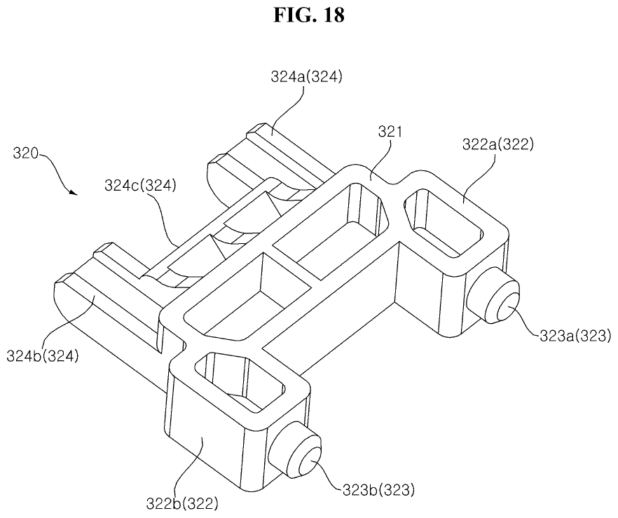

Referring to FIG. 18, the bracket hinge slider 300 may include at least one of a slider body 321, a sliding supporter 322, a cam pusher 324, and a spring insert 323. The slider body 321 may have a block shape. The sliding supporter 322 may extend from the slider body 321. There may be a plurality of sliding supporters 322. For example, the sliding supporter 322 may be a pair. The pair of sliding supporters 322a, 322b may be spaced apart from each other and may extend from the slider body 321. The spring insert 323 may form a distal end of the sliding supporter 322. The spring insert 323a, 323b may protrude from the distal end of the sliding supporter 322.

The cam pusher 324 may protrude and extend from the slider body 321. The cam pusher 324 may be positioned opposite to the sliding supporter 322 with respect to the slider body 321. There may be a plurality of cam pushers. The cam pusher 324 may include at least one of a first cam pusher 324a, a second cam pusher 324b, and a third cam pusher 324c. The first cam pusher 324a may be parallel to the second cam pusher 324b. The third cam pusher 324c may be positioned between the first cam pusher 324a and the second cam pusher 324b. The first cam pusher 324a and/or the second cam pusher 324b may protrude from the third cam pusher 324c. The first cam pusher 324a and/or the second cam pusher 324b may be referred to as cam guide 324a, 324b.

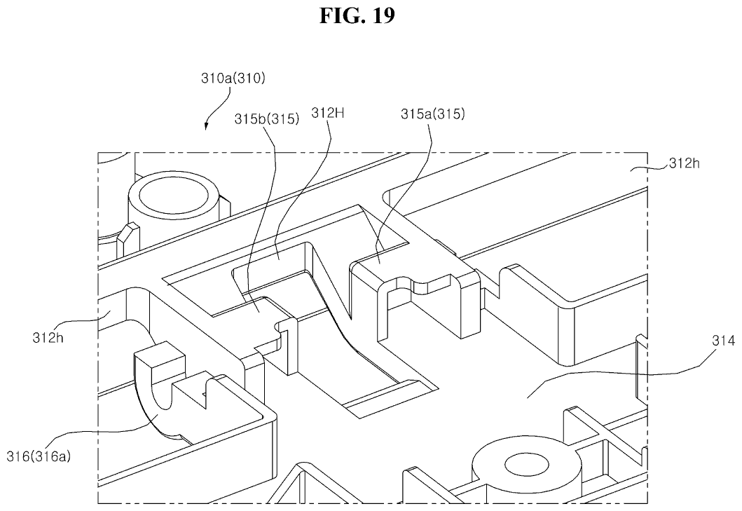

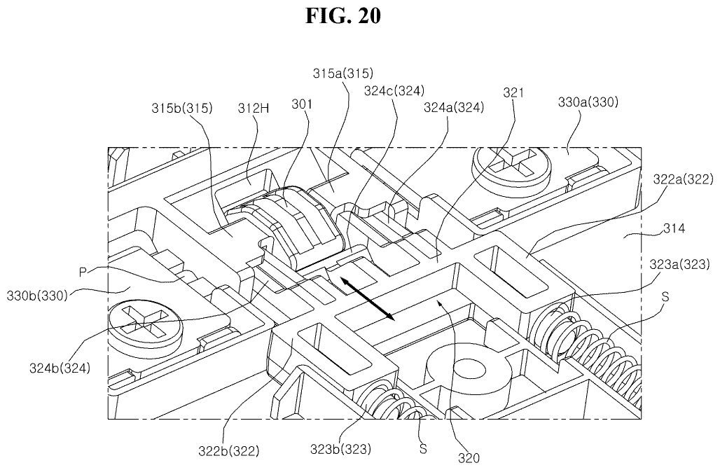

Referring to FIGS. 19 and 20, the body frame 310a may include a slider base 314. The slider base 314 may form an inner surface of the body frame 310a. The slider base 314 may have a shape corresponding to the bracket hinge slider 320. The slider base 314 may support the bracket hinge slider 320. The bracket hinge slider 320 may move on the slider base 314.

A pusher holding gate 315 may be formed around the cam hole 312H. There may be a plurality of pusher holding gates 315. A first cam pusher 324a may be inserted into a first pusher holding gate 315a. A second cam pusher 324b may be inserted into a second pusher holding gate 315b. A third cam pusher 324c may be positioned adjacent to the cam hole 312H.

A cam 301 of the folio bracket 300C may be inserted into the cam hole 312H.

The elastic member S may support the sliding supporter 322. For example, the elastic member S may be a coil spring. The spring insert 323 may be inserted into the elastic member S.

Accordingly, the bracket hinge slider 320 may reciprocally move on the slider base 314 of the body frame 310a. In addition, the bracket hinge slider 320 may be assembled with the elastic member S in the body frame 310a while minimizing movement.

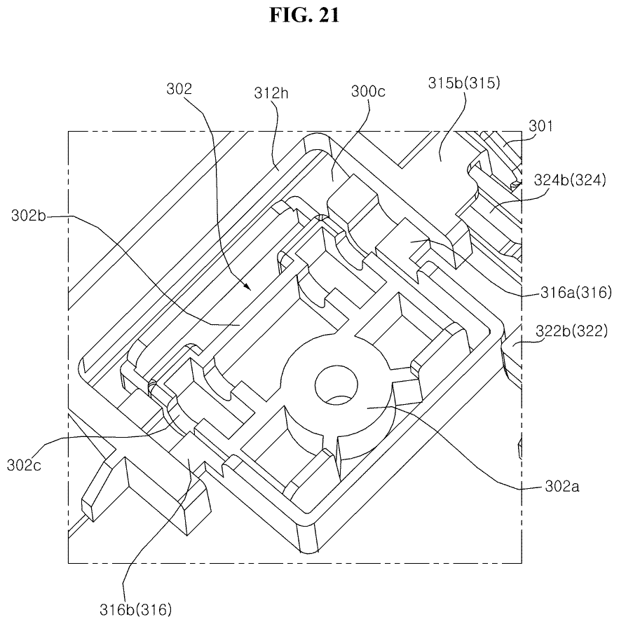

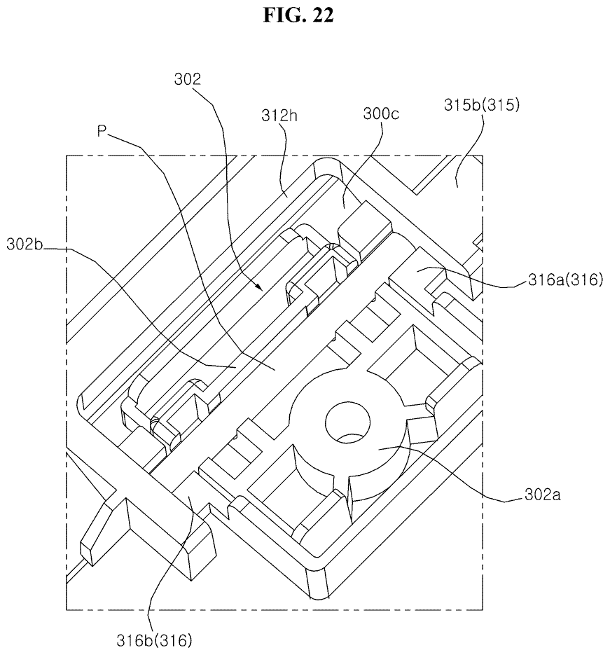

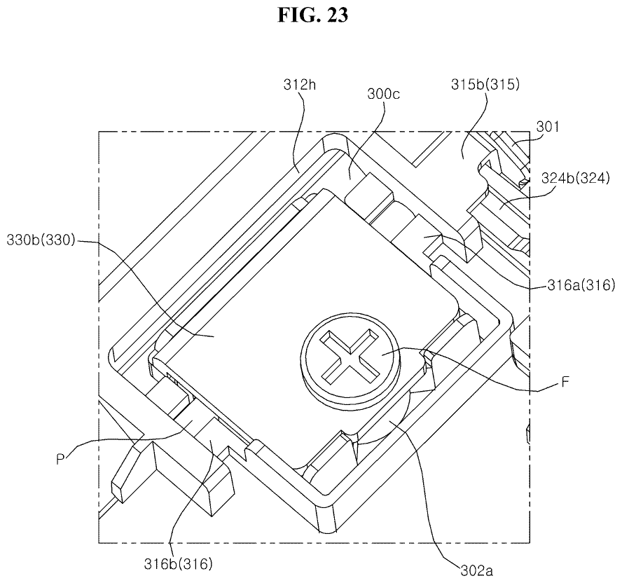

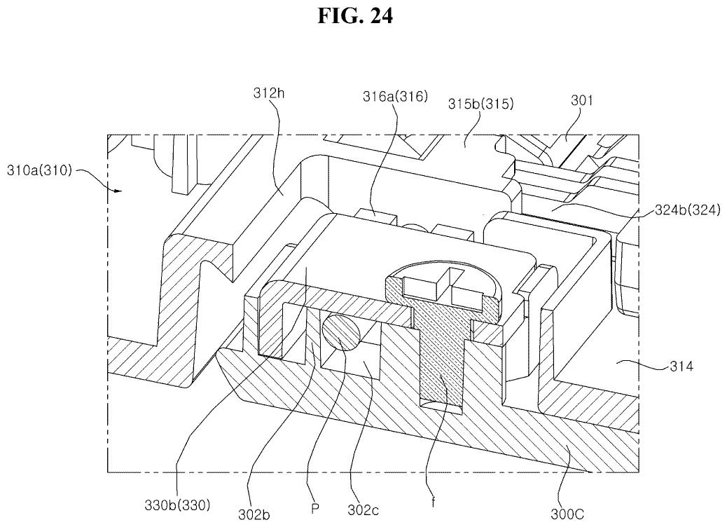

Referring to FIGS. 21 to 25, a hinge coupling portion 302 of the folio bracket 300C may be inserted into the coupling opening 312h of the body frame 310a (see FIG. 17). The hinge coupling portion 302 may include at least one of a fixing boss 302a, a coupling frame 302b, and a pin holder 302c. The fixing boss 302a may protrude from the inner surface of the folio bracket 300C. A screw hole may be formed in the fixing boss 302a. The coupling frame 302b may be adjacent to the fixing boss 302a. The pin holder 302c may be formed in the coupling frame 302b. For example, the pin holder 302c may be a half pipe.

The body frame 310a (see FIG. 17) may include a pin hinge portion 316. The pin hinge portion 316 may be formed at one side of the coupling opening 312h. There may be a plurality of pin hinge portions 316. A first pin hinge portion 316a may be formed at one side of the coupling opening 312h. A second pin hinge portion 316b may be formed at the other side of the coupling opening 312h. The first pin hinge portion 316a may face the second pin hinge portion 316b. The pin hinge portion 316 may have a half-pipe shape. The pin P may be inserted into the pin holder 302c and the pin hinge portion 316. The pin coupler 330 has a hole corresponding to the screw hole of the fixing boss 302a, and may be fixed to the hinge coupling portion 302 by screwing the fastening member F into the screw hole through the hole. The pin coupler 330 may cover the pin P and fix the pin P to the pin holder 302c of the hinge coupling portion 302. Accordingly, the folio cover 300C may be hinge-connected to the body frame 310a (see FIG. 17).

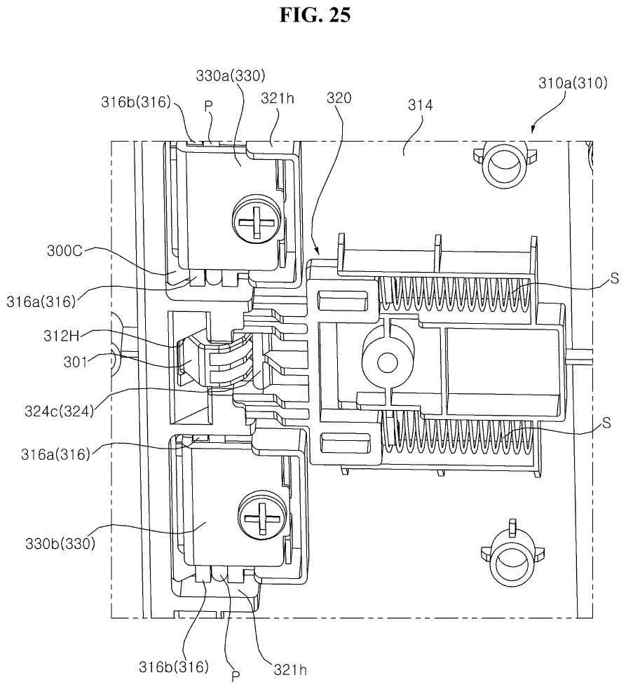

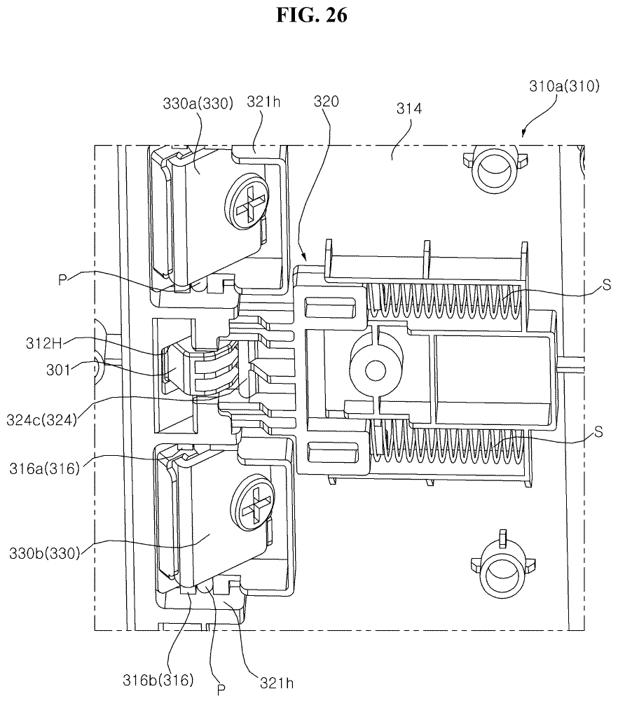

Referring to FIGS. 25 and 26, the folio bracket 300C may pivot or tilt about the pin P with respect to the body frame 310a. As the folio bracket 300C moves, the cam 301 inserted into the cam hole 312H may rotate about the pin P.

The third cam pusher 324c of the bracket hinge slider 320 may be in contact with the cam 301 of the folio bracket 300C. As the folio bracket 300C pivots or tilts, the bracket hinge slider 320 may reciprocally move. The bracket hinge slider 320 may continuously provide a constant force to the cam 301 of the folio bracket 300C by the elastic force provided by the elastic member S.

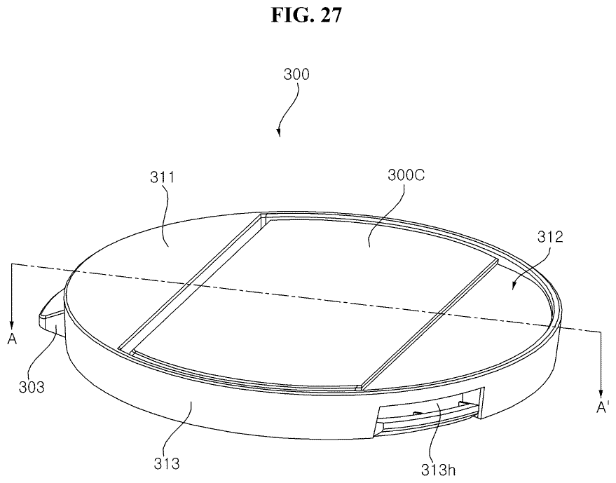

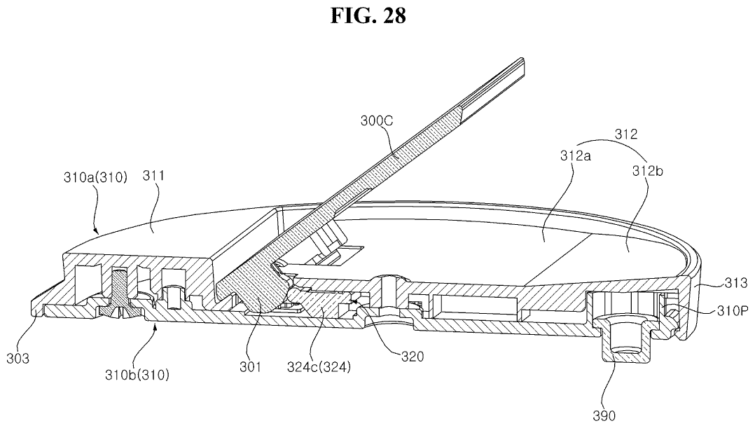

FIG. 28 is a drawing showing an example of a cross-section of A-A′ of FIG. 27. Referring to FIG. 27 and FIG. 28, the folio bracket 300C may pivot or tilt about the cam 301. The bracket mount 312 may include a flat portion 312a and an inclined portion 312b. The flat portion 312a may form a low step from the outer plate 311 of the body frame 310a. The inclined portion 312b may extend from the flat portion 312a. The inclined portion 312b may extend from the flat portion 312a to the edge of the side plate 313. The inclined portion 312b may form an obtuse angle with respect to the flat portion 312a.

The folio bracket 300C may cover the flat portion 312a. The edge of the folio bracket 300C positioned opposite to the cam 301 may be adjacent to or overlapped with the inclined portion 312b.

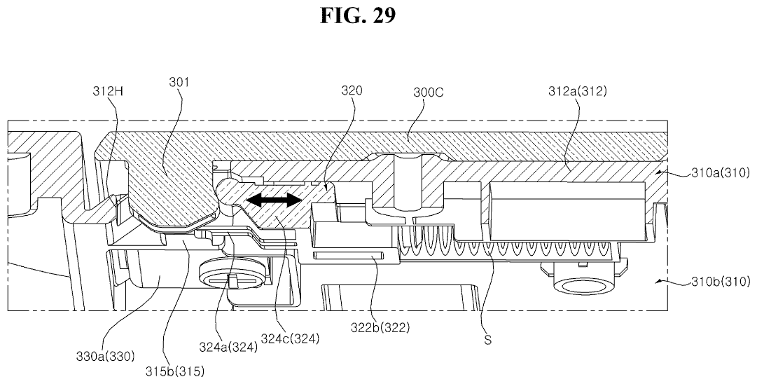

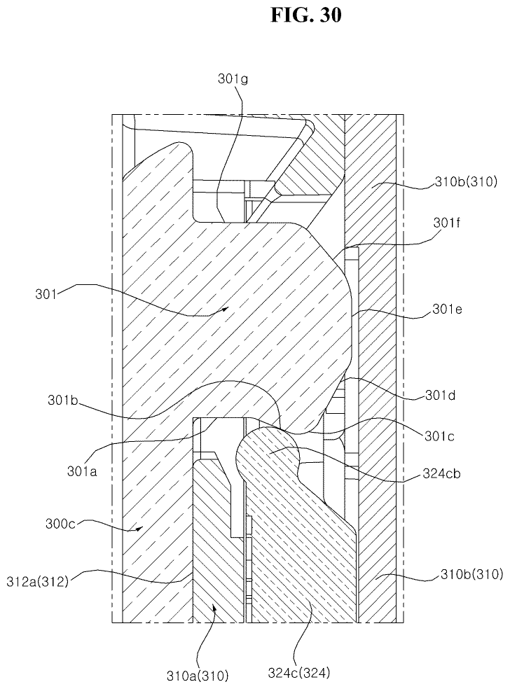

Referring to FIGS. 29 and 30, the third cam pusher 324c may include an end tip 324cb. The end tip 324cb may contact the cam 301. For example, the end tip 324cb may be a rounded bar or a round ball. When the folio bracket 300C pivots or tilts with respect to the cam 301, the bracket hinge slider 320 may reciprocally move.

The cam 301 of the folio bracket 300C may have a plurality of cross sections 301a, 301b, 301c, 301d, 301e, 301f, and 301g. A first surface 301a may extend in a direction intersecting with the plane direction of the folio bracket 300C from the inner surface of the folio bracket 300C. For example, the first surface 301a may form a right angle to the inner surface of the folio bracket 300C.

A second surface 301b may form an incline with respect to the first surface 301a. The second surface 301b may form an inwardly recessed boundary with the first surface 301a. The second surface 301b may be in contact with the end tip 324cb at a location where the folio bracket 300C is supported by the bracket mount 312.

A third surface 301c may form a distal end of the second surface 301b. The third surface 301c may form a surface that is rounded at the distal end of the second surface 301b. A fourth surface 301d may extend from the third surface 301c. The fourth surface 301d may form a straight surface.

A fifth surface 301e may extend from the fourth surface 301d in a direction parallel to the plane of the folio bracket 300C. A sixth surface 301f may extend in a curved manner from the fifth surface 301e. A seventh surface 301g may be parallel to the first surface 301a. The seventh surface 301g may extend from the inner surface of the folio bracket 300C. The sixth surface 301f may form an incline with respect to the fifth surface 301e and/or the seventh surface 301g.

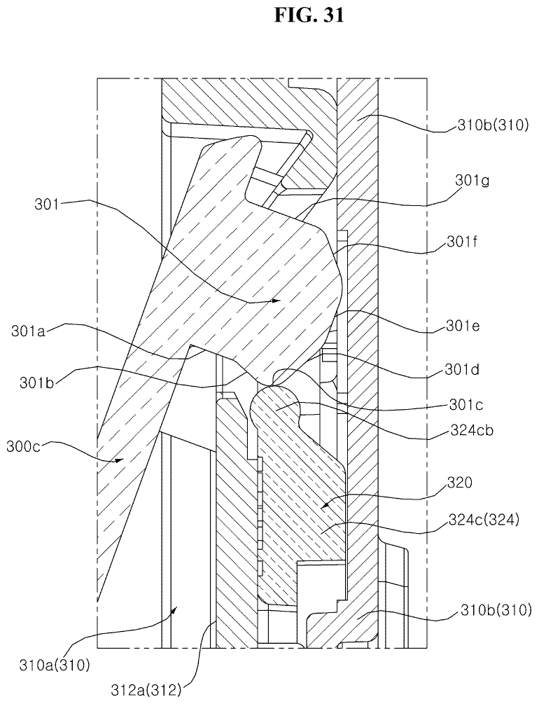

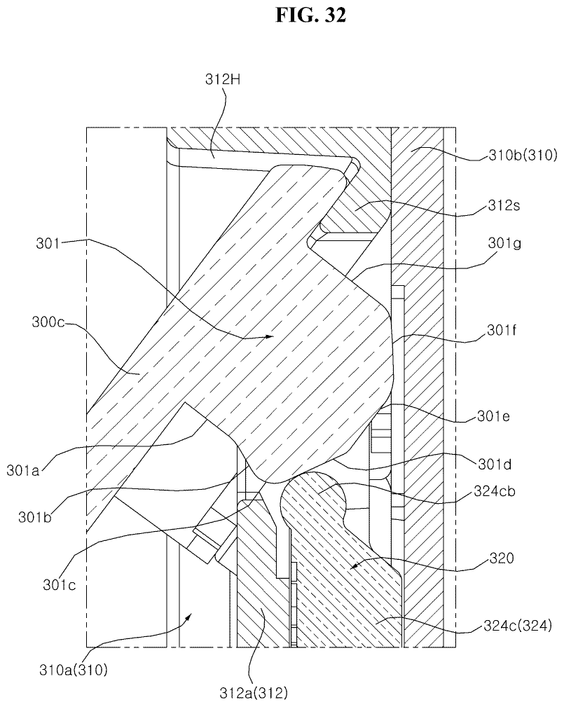

Referring to FIGS. 31 and 32, when the folio bracket 300C starts to pivot or tilt, the end tip 324cb may come into contact with the second surface 301b and/or the third surface 301c of the cam 301. The end tip 324cb may slide and move on the second surface 301b and/or the third surface 301c of the cam 301. The radius of curvature of the third surface 301c may be smaller than the radius of curvature of the end tip 324cb. The end tip 324cb may be in a state of receiving an elastic force directed from the third surface 301c toward the cam 301.

Accordingly, the end tip 324cb may not maintain contact with the third surface 301c, and may slide to the second surface 301b or the fourth surface 301d. Although the end tip 324cb is described as moving with respect to the surfaces 301a, 301b, 301c, 301d of the cam 301, it can be understood that the surfaces 301a, 301b, 301c, 301d of the cam 301 move with respect to the end tip 324cb as the cam 301 and the folio bracket 300C pivot or rotate.

The cam hole 312H may be provided with a stopper 312s. The stopper 312s may be formed on one side of the cam hole 312H. The distal end of the folio bracket 300C may be caught on the stopper 312s. At this time, the end tip 324cb may be in contact with the fourth surface 301d.

Accordingly, the folio bracket 300C may be tilted with respect to the cam 301 or converted to a flat state supported by the bracket mount 312. That is, the end tip 324cb may maintain a state of being in contact with the second surface 301b or the fourth surface 301d for a long time, and the state of being in contact with the third surface 301c may be instantaneously achieved.

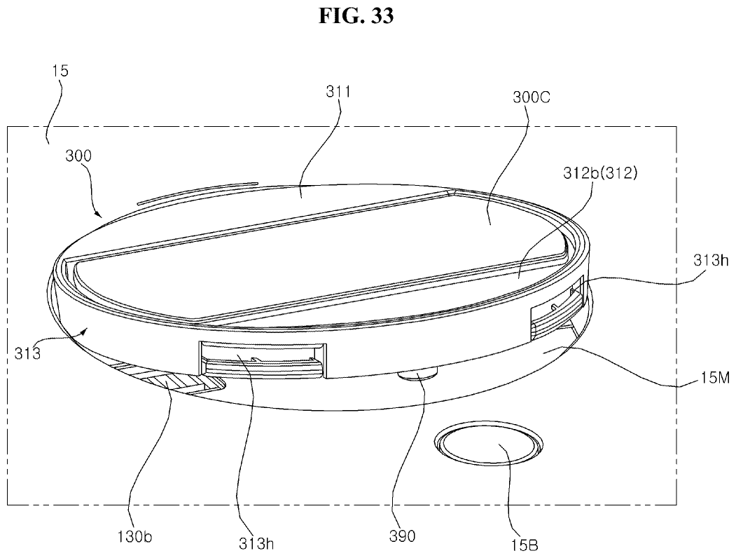

Referring to FIG. 33, the bracket assembly 300 may be coupled to or separated from the mount 15M of the back cover 15 of the display head 10 (see FIG. 16). The bracket assembly 300 may be popped up from the mount 15M of the back cover 15 by pressing the button 15B. When the hook HK (see FIG. 15) inserted into the hook coupling groove 313h is removed by pressing the button 15B to separate the bracket assembly 300, the bracket assembly 300 may be popped up from the mount 15M of the back cover 15.

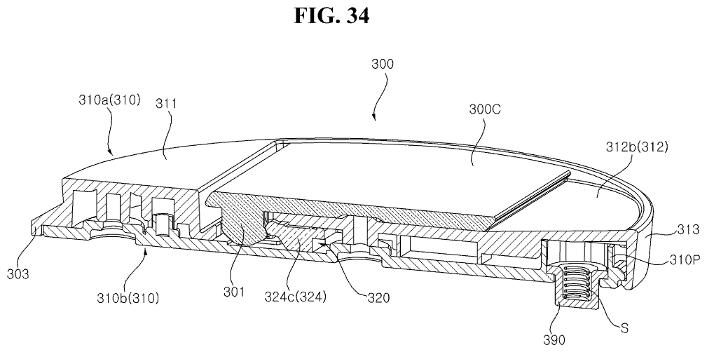

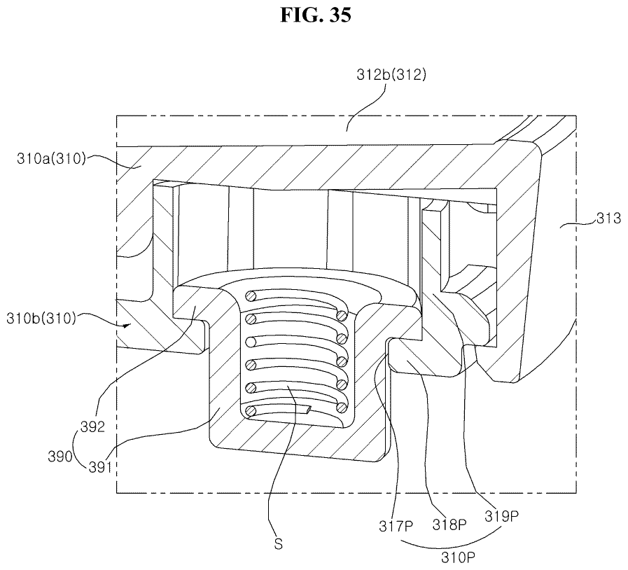

Referring to FIGS. 34 and 35, the ejector 390 may include an ejecting body 391 and a flange 392. The ejecting body 391 may have a hollow cylindrical shape. The flange 392 may be formed at the opening-side distal end of the ejecting body 391. The outer diameter of the flange 392 may be larger than the outer diameter of the ejecting body 391.

The body cover 310b may include an ejector housing 310P. The ejector housing 310P may include at least one of a housing body 319P, a pop-up hole 317P, and a flange stopper 318P. The housing body 319P may have a cylindrical shape. The pop-up hole 317P may form one side of the housing body 319P. The pop-up hole 317P may penetrate the body cover 310b. The flange stopper 318P may form a diameter of the pop-up hole 317P. The inner diameter of the flange stopper 318P or the diameter of the pop-up hole 317P may correspond to an outer diameter of the ejecting body 391.

One side of the elastic member S may be supported by the body frame 310a and the other side may be supported by the ejector 390. For example, the elastic member S may be a coil spring. The elastic member S may be inserted into the ejecting body 391.

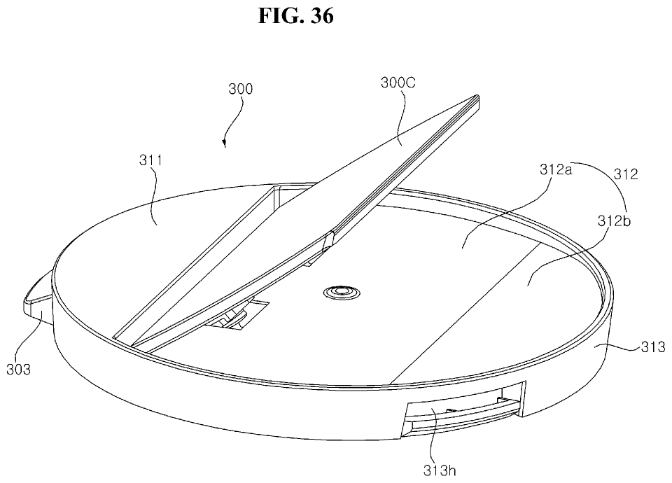

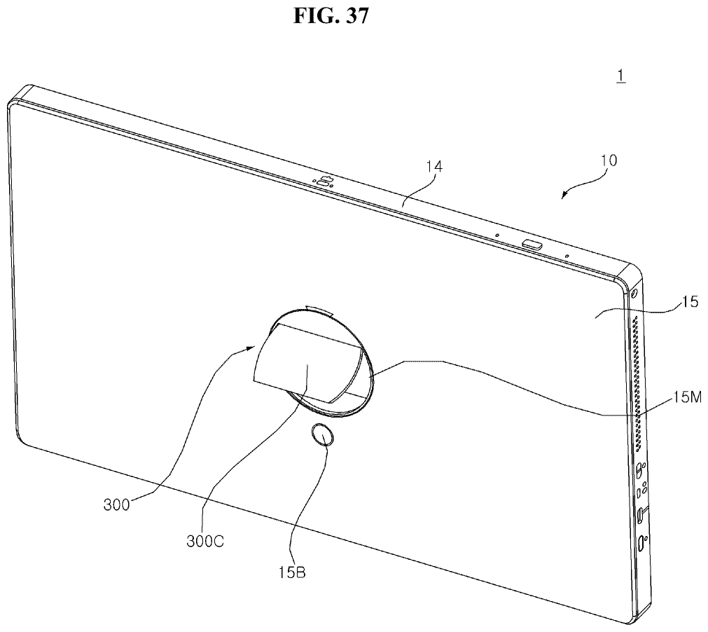

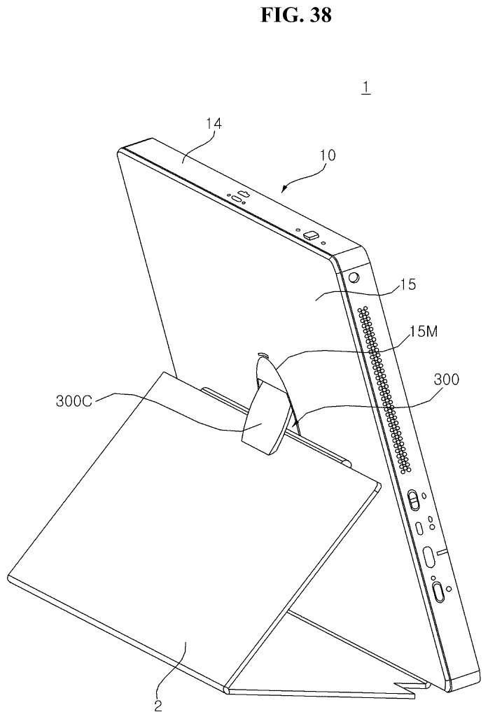

Referring to FIGS. 36 to 39, the folio bracket 300C of the bracket assembly 300 may be pivoted or tilted on the bracket mount 312 (see FIG. 36). When the bracket assembly 300 is coupled to the mount 15M of the back cover 15 of the display head 10, the protrusion 303 of the bracket assembly 300 may be inserted into the fixing hole H of the mount 15M of the back cover 15, and the folio bracket 300C may pivot or tilt.

One side of the folio cover 2 may be coupled to one side of the display head 10, and when folded, the other side may be inserted into between the folio bracket 300C of the bracket assembly 300 and the bracket mount 312 (see FIG. 36). For example, one side of the folio cover 2 may be inserted into and fixed to the side frame 14, and the other side of the folio cover 2 may be fixed by the bracket assembly 300. Accordingly, the display head 10 may be supported by the folio cover 2 folded between one side and the other side.

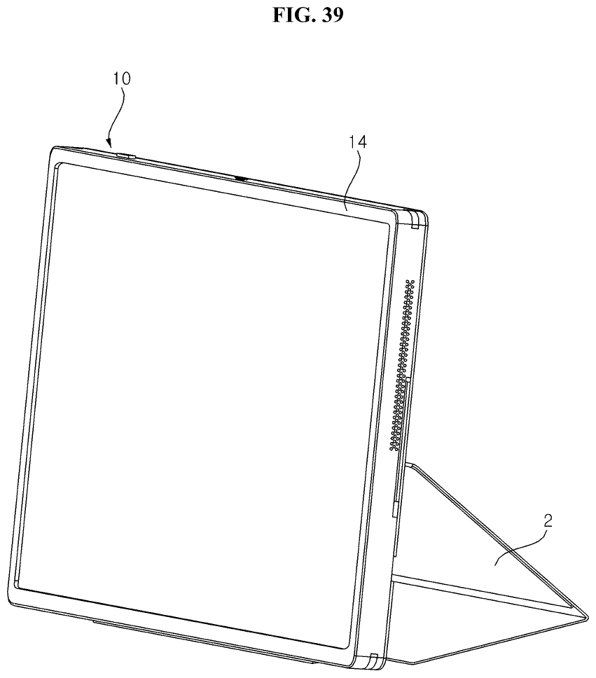

Referring to FIGS. 1 and 39, a display device includes: a display panel; a frame to which the display panel is coupled; a back cover which is coupled to the frame, and positioned opposite to the display panel with respect to the frame; and a bracket assembly which is coupled to the back cover, and is detachable, in which the bracket assembly includes: a body frame coupled to the back cover; and a folio bracket which is hinge-connected to the body frame, and is able to tilt.

The bracket assembly further includes: a body cover which is positioned opposite to the folio braket with respect to the body frame, and is coupled with the body frame; and a bracket hinge slider which reciprocates between the body frame and the body cover, in which the bracket hinge slider reciprocates in conjunction with tilting of the folio bracket.

The folio bracket includes a cam which provides a tilting center of the folio bracket, and is in contact with one side of the bracket hinge slider through the body frame, in which the bracket hinge slider includes a cam pusher which is in contact with the cam.

The body frame includes: a bracket mount facing the folio bracket; and a cam hole penetrating the bracket mount, in which the cam is inserted through the cam hole of the body frame, in contact with the cam pusher, and positioned between the body frame and the body cover.

The body frame includes a coupling opening which is adjacent to the cam hole, and penetrates the bracket mount, and the folio bracket includes a coupling portion positioned at the coupling opening of the body frame, in which the coupling portion of the folio bracket is hinge-connected to the body frame at the coupling opening of the body frame.

The body frame includes a holding gate which is adjacent to the cam hole and formed in the body frame at between the body frame and the body cover, and the bracket hinge slider includes a cam guide which is adjacent to the cam, and inserted into the holding gate.

The bracket hinge slider includes: a slider body on which the cam pusher is formed; and a sliding supporter which is positioned opposite to the cam pusher with respect to the slider body, and formed on the slider body, and the bracket assembly includes an elastic member which has one side that is supported by the sliding supporter, and has the other side that is supported by at least one of the body frame and the body cover, at between the body frame and the body cover.

The cam includes: a first surface connected to the folio bracket; a second surface connected to the first surface; a third surface which is connected to the second surface, and forms a curved surface; and a fourth surface connected to the third surface, and the cam pusher is in contact with any one of the second surface and the fourth surface according to the tilting of the folio bracket.

The cam has the second surface, the third surface, and the fourth surface that form a wedge shape.

The cam pusher comes in contact with the third surface while moving from the second surface to the fourth surface, or while moving from the fourth surface to the second surface.

The bracket assembly includes: an ejector housing formed in the body cover; and an ejector protruding to an outside of the body cover from the ejector housing, and, in the bracket assembly, the body cover faces the back cover.

The ejector housing includes: a pop-up hole penetrating the body cover; and a housing body formed around the pop-up hole, at between the body frame and the body cover, and the ejector includes: an ejecting body moving within the pop-up hole; and a flange which is formed at a distal end of the ejecting body, and positioned in the housing body, in which an outer diameter of the ejecting body corresponds to a diameter of the pop-up hole, and an outer diameter of the flange is larger than the diameter of the pop-up hole.

The bracket assembly includes: a body frame; a body cover which faces the body frame, and is coupled to the body frame; a bracket hinge slider which reciprocates between the body frame and the body cover; and a folio bracket which is positioned opposite to the body cover with respect to the body frame, and is hinge-connected to the body frame and able to tilt, in which the bracket hinge slider reciprocates in conjunction with tilting of the folio bracket.

The folio bracket includes a cam which provides a tilting center of the folio bracket, and is in contact with one side of the bracket hinge slider through the body frame, and the bracket hinge slider includes a cam pusher which is in contact with the cam.

The body frame includes: a bracket mount facing the folio bracket; and a cam hole penetrating the bracket mount, and the cam is inserted through the cam hole of the body frame, in contact with the cam pusher, and positioned between the body frame and the body cover.

The body frame includes a coupling opening which is adjacent to the cam hole, and penetrates the bracket mount, and the folio bracket includes a coupling portion positioned at the coupling opening of the body frame, in which the coupling portion of the folio bracket is hinge-connected to the body frame at the coupling opening of the body frame.

The body frame includes a holding gate which is adjacent to the cam hole and formed in the body frame at between the body frame and the body cover, and the bracket hinge slider includes a cam guide which is adjacent to the cam, and inserted into the holding gate.

The bracket hinge slider includes: a slider body on which the cam pusher or the cam guide is formed; a sliding supporter which is positioned opposite to the cam pusher with respect to the slider body, and formed on the slider body, and the bracket assembly includes an elastic member which has one side that is supported by the sliding supporter, and has the other side that is supported by at least one of the body frame and the body cover, at between the body frame and the body cover.

The cam includes: a first surface connected to the folio bracket; a second surface connected to the first surface; a third surface which is connected to the second surface, and forms a curved surface; and a fourth surface connected to the third surface, and the cam pusher is in contact with any one of the second surface and the fourth surface according to the tilting of the folio bracket.

The cam pusher comes in contact with the third surface while moving from the second surface to the fourth surface, or while moving from the fourth surface to the second surface.

The effects of the bracket assembly and the display device including the same according to the present disclosure are described as follows.

According to at least one of the embodiments of the present disclosure, a display device having a stand for supporting a display may be provided.

According to at least one of the embodiments of the present disclosure, a display device capable of freely adjusting the angle or height of a display may be provided.

According to at least one of the embodiments of the present disclosure, a display device capable of improving durability for freely adjusting the angle or height of a display and repeated operations may be provided.

According to at least one of the embodiments of the present disclosure, a display device capable of attaching a display to a stand or detaching the display from the stand may be provided.

According to at least one of the embodiments of the present disclosure, a display device having a folio bracket assembly for mounting a display may be provided.

According to at least one of the embodiments of the present disclosure, a display device capable of being mounted by a folio cover may be provided.

Certain embodiments or other embodiments of the invention described above are not mutually exclusive or distinct from each other. Any or all elements of the embodiments of the invention described above may be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments may be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display device comprising:
a display;
a frame to which the display is coupled;
a back cover which is coupled to the frame, and positioned opposite to the display with respect to the frame; and
a bracket assembly which is coupled to the back cover, and is detachable,
wherein the bracket assembly comprises:
a body frame coupled to the back cover; and
a folio bracket which is hinge-connected to the body frame, and is able to tilt.

2. The display device of claim 1, wherein the back cover further comprises a mount forming a low step from a rear surface, and the bracket assembly is detachably coupled to the mount.

3. The display device of claim 2, wherein the bracket assembly has a hook coupling groove 313h on a side surface, and the mount has a hook hole 15Hh on an inner circumferential surface,
wherein the back cover comprises a coupling hook HK which is installed inside, and inserted into the hook coupling groove through the hook hole, and a button configured to separate the coupling hook from the hook coupling groove by a pressing operation.

4. The display device of claim 1, wherein the bracket assembly further comprises:
a body cover which is positioned opposite to the folio bracket with respect to the body frame, and is coupled with the body frame; and
a bracket hinge slider which reciprocates between the body frame and the body cover,
wherein the bracket hinge slider reciprocates in conjunction with tilting of the folio bracket.

5. The display device of claim 4, wherein the folio bracket comprises a cam which provides a tilting center of the folio bracket, and is in contact with one side of the bracket hinge slider through the body frame,
wherein the bracket hinge slider comprises a cam pusher which is in contact with the cam.

6. The display device of claim 5, wherein the body frame comprises:
a bracket mount facing the folio bracket; and
a cam hole penetrating the bracket mount,
wherein the cam is inserted through the cam hole of the body frame, in contact with the cam pusher, and positioned between the body frame and the body cover.

7. The display device of claim 6, wherein the body frame comprises a coupling opening which is adjacent to the cam hole, and penetrates the bracket mount,
wherein the folio bracket comprises a coupling portion positioned at the coupling opening of the body frame, and
wherein the coupling portion of the folio bracket is hinge-connected to the body frame at the coupling opening of the body frame.

8. The display device of claim 6, wherein the body frame comprises a holding gate which is adjacent to the cam hole and formed in the body frame at between the body frame and the body cover,
wherein the bracket hinge slider comprises a cam guide which is adjacent to the cam, and inserted into the holding gate.

9. The display device of claim 8, wherein the bracket hinge slider comprises:
a slider body on which the cam pusher is formed; and
a sliding supporter which is positioned opposite to the cam pusher with respect to the slider body, and formed on the slider body,
wherein the bracket assembly comprises an elastic member which has one side that is supported by the sliding supporter, and has the other side that is supported by at least one of the body frame and the body cover, at between the body frame and the body cover.

10. The display device of claim 5, wherein the cam comprises:
a first surface connected to the folio bracket;
a second surface connected to the first surface;
a third surface which is connected to the second surface, and forms a curved surface; and
a fourth surface connected to the third surface,
wherein the cam pusher is in contact with any one of the second surface and the fourth surface according to the tilting of the folio bracket.

11. The display device of claim 10, wherein the cam has the second surface, the third surface, and the fourth surface that form a wedge shape.

12. The display device of claim 10, wherein the cam pusher comes in contact with the third surface while moving from the second surface to the fourth surface, or while moving from the fourth surface to the second surface.

13. The display device of claim 4, wherein the bracket assembly comprises:
an ejector housing formed in the body cover; and
an ejector protruding to an outside of the body cover from the ejector housing,
wherein, in the bracket assembly, the body cover faces the back cover.

14. The display device of claim 13, wherein the ejector housing comprises:
a pop-up hole penetrating the body cover; and
a housing body formed around the pop-up hole, at between the body frame and the body cover,
wherein the ejector comprises:
an ejecting body moving within the pop-up hole; and
a flange which is formed at a distal end of the ejecting body, and positioned in the housing body,
wherein an outer diameter of the ejecting body corresponds to a diameter of the pop-up hole,
wherein an outer diameter of the flange is larger than the diameter of the pop-up hole.

15. The display device of claim 1, further comprising:
a side frame covering a lateral side of the frame; and
a folio cover which has one side coupled to the side frame, has the other side supported by the folio bracket, and is foldable between the one side and the other side.

16. A display device comprising:
a display including a display panel; and
a folio cover coupled to the display,
wherein the display comprises:
a side frame forming an edge of the display;
a back cover forming a rear surface of the display;
a battery positioned inside the display; and
a bracket assembly which is coupled to the back cover, and detachable from the back cover,
wherein the folio cover has one side coupled to the side frame, and has the other side supported by the bracket assembly.

17. The display device of claim 16, wherein the bracket assembly comprises:
a body frame;
a body cover which faces the body frame, and is coupled to the body frame;
a bracket hinge slider which reciprocates between the body frame and the body cover; and
a folio bracket which is positioned opposite to the body cover with respect to the body frame, and is hinge-connected to the body frame and able to tilt,
wherein the bracket hinge slider reciprocates in conjunction with tilting of the folio bracket.

18. The display device of claim 17, wherein the folio bracket comprises a cam which provides a tilting center of the folio bracket, and is in contact with one side of the bracket hinge slider through the body frame,
wherein the bracket hinge slider comprises a cam pusher which is in contact with the cam.

19. The display device of claim 18, wherein the body frame comprises:
a bracket mount facing the folio bracket; and
a cam hole penetrating the bracket mount,
wherein the cam is inserted through the cam hole of the body frame, in contact with the cam pusher, and positioned between the body frame and the body cover.

20. The display device of claim 19, wherein the body frame comprises a coupling opening which is adjacent to the cam hole, and penetrates the bracket mount,
wherein the folio bracket comprises a coupling portion positioned at the coupling opening of the body frame, and
wherein the coupling portion of the folio bracket is hinge-connected to the body frame at the coupling opening of the body frame.

21. The display device of claim 19, wherein the body frame comprises a holding gate which is adjacent to the cam hole and formed in the body frame at between the body frame and the body cover,
wherein the bracket hinge slider comprises a cam guide which is adjacent to the cam, and inserted into the holding gate.

22. The display device of claim 21, wherein the bracket hinge slider comprises:
a slider body on which the cam pusher or the cam guide is formed; and
a sliding supporter which is positioned opposite to the cam pusher with respect to the slider body, and formed on the slider body,
wherein the bracket assembly comprises an elastic member which has one side that is supported by the sliding supporter, and has the other side that is supported by at least one of the body frame and the body cover, at between the body frame and the body cover.

23. The display device of claim 22, wherein the cam comprises:
a first surface connected to the folio bracket;
a second surface connected to the first surface;
a third surface which is connected to the second surface, and forms a curved surface; and
a fourth surface connected to the third surface,
wherein the cam pusher is in contact with any one of the second surface and the fourth surface according to the tilting of the folio bracket.

24. The display device of claim 23, wherein the cam pusher comes in contact with the third surface while moving from the second surface to the fourth surface, or while moving from the fourth surface to the second surface.

25. A display device comprising:
a display which displays an image on a front surface; and
a back cover forming a rear surface of the display,
wherein the back cover comprises a mount forming a low step from a rear surface of the back cover,
wherein any one of a bracket assembly which supports a folio cover for mounting the display and a connector, which is provided on a stand that supports the display and is movable, is coupled to the mount.

26. The display device of claim 25, wherein the bracket assembly is detachably coupled to the mount.

27. The display device of claim 26, wherein the bracket assembly has a hook coupling groove 313h on a side surface, and the mount has a hook hole 15Hh on an inner circumferential surface,
wherein the back cover comprises a coupling hook HK which is installed inside, and inserted into the hook coupling groove through the hook hole, and a button configured to separate the coupling hook from the hook coupling groove by a pressing operation.
